(19) United States
(12) Patent Application Publication
(10) Pub. No.: US 2011/0031827 A1
(43) Pub. Date: Feb. 10, 2011

(54) ENERGY STORAGE DEVICE COMPRISING A FLYWHEEL

(75) Inventor: Andre Rene Georges Gennesseaux, Conie-molitard (FR)

Correspondence Address: SEED INTELLECTUAL PROPERTY LAW GROUP PLLC, 701 FIFTH AVE, SUITE 5400, SEATTLE, WA, 98104, US

(73) Assignee: Energiestro, Conie-molitard (FR)

(21) Appl. No.: 12/936,880

(22) PCT Filed: Apr. 7, 2008
(86) PCT No.: PCT/IB08/53123

§ 371 Date: Oct. 7, 2010

(51) Int. Cl. H02K 7/02

(52) U.S. Cl. 310/74

(57) ABSTRACT

Energy storage device comprising a flywheel a stator arrangement and a housing.

The flywheel, rotatably mounted around a rotation axis, comprises a shaft, a plurality of adjacent magnetic plates with magnetic poles, two kinetic plates, sandwiching the magnetic plates. The magnetic plates and kinetic plates are rotationally rigid with said shaft.

The stator arrangement comprises a plurality of induction coils cooperating with the magnetic poles.

### FIELD OF THE INVENTION

The invention relates to an energy storage device comprising a flywheel.

Such an energy storage device is for instance used in autonomous power generating systems.

More precisely, the invention concerns an energy storage device comprising:
a flywheel rotatably mounted around a rotation axis, said flywheel comprising a shaft and a plurality of magnetic poles,
a stator arrangement, facing the magnetic poles of said flywheel, comprising a plurality of induction coils cooperating with said magnetic poles,
a housing enclosing the flywheel and the stator arrangement.

### BACKGROUND OF THE INVENTION

Patent application WO2005/043721 discloses an energy storage device comprising a flywheel able to store kinetic energy and a generator arrangement to provide electrical power from this kinetic energy. The flywheel is made of a single part from a ferromagnetic material.

However, this solution has at least two drawbacks. Firstly, to limit the losses by Foucault currents, it is necessary to machine very thin and deep grooves on the magnetic pole areas, which requires special and costly machining techniques on such a big part. Secondly, an unsatisfactory compromise is to be done about the choice of the material: some materials have very good magnetic properties, but poor resistance to high stress and fatigue undergone due to the flywheel velocity and cyclic operation, while other materials have a good resistance to high stress and fatigue but less beneficial magnetic properties.

### OBJECTS AND SUMMARY OF THE INVENTION

One object of the invention is to alleviate at least part of the above mentioned drawbacks.

To this end, the energy storage device according to the invention is characterized in that the flywheel comprises:
a plurality of magnetic plates, mounted on said shaft,
a first and second kinetic plates, adjacent to said magnetic plates, sandwiching the magnetic plates, wherein the magnetic plates and kinetic plates are rotationally rigid with the shaft and extend radially relative to said shaft.

Thanks to these dispositions, it is possible to uncouple the two main technical functions of the flywheel; on one hand storing mechanical energy, and on the other hand electromagnetically cooperating with the stator for transforming this mechanical energy in electricity when needed:
the mechanical energy may be stored mainly in the kinetic plates, which may be made of a material chosen for its good mechanical properties, and which does not need to have excellent magnetic properties,
the electromagnetic cooperation with the stator is carried out by the magnetic plates, which may be made of a material chosen for its good magnetic properties and which does not need to have excellent mechanical properties (the magnetic plates may be designed so that they store only a minor part of the kinetic energy of the flywheel when the flywheel is rotated, and so that the mechanical stresses in said magnetic plates are lower than in the kinetic plates).

Therefore, the choice of materials for the kinetic plates and magnetic plates may be optimized, and further it is often possible to choose less costly materials as compared to the prior art without diminishing the mechanical and magnetic performance of the flywheel.

Further, the use of several magnetic plates enables to limit the magnetic losses by Foucault currents.

Summarizing, the invention enables to store a high amount of kinetic energy in a small or limited volume, with a good safety margin regarding centrifugal force stress, while the optimization of the magnetic losses improves the mechanical-to-electrical yield, resulting in a compact and efficient energy storage device.

In various embodiments of the invention, one and/or the other of the following features may be incorporated:
the magnetic plates have an external diameter and the kinetic plates have an external diameter which is greater than seventy percent of the external diameter of the magnetic plates;
the first and second kinetic plates have together a first moment of inertia and the magnetic plates have together a second moment of inertia, and the first moment of inertia is greater than the second moment of inertia;
the shaft comprises at least a spline, each of the magnetic plates and the kinetic plates having at least a complementary groove receiving said spline, so that the magnetic plates and kinetic plates are rotationally rigid with said shaft;
the energy storage device comprises a locking pin, the shaft comprises a groove and each of the magnetic plates and the kinetic plates have a corresponding groove, so that the locking pin is lodged in said grooves, to render the magnetic plates and kinetic plates rotationally rigid with said shaft;
the kinetic plates are made of spheroidal graphite cast iron;
the spheroidal graphite cast iron has a ferrite structure;
the kinetic plates comprise a central portion, a peripheral rim and an intermediate portion which is located radially between the central portion and the peripheral rim, said peripheral rim being thicker in a direction parallel to the rotation axis, than said intermediate portion;
the kinetic plates are monoblock and axisymmetric;
the energy storage comprises a balance mass bonded on an inner rim belonging to at least one of the kinetic plates, said inner rim being oriented radially inwardly;
the housing is an airtight housing, and the energy storage device further includes a vacuum pump for creating a vacuum inside said housing;
the kinetic plates are at least partially coated with paint and the inner sides of the housing facing the kinetic plates are coated with paint, said paint being adapted to favour radiated heat transfer;
the stator arrangement comprises at least an excitation coil, and at least an inducted coil, forming a magnetic circuit with the magnetic poles and the housing;
the kinetic plates comprise a bevel at the peripheric area facing the magnetic plates, said bevel forming with the magnetic plates an empty wedge adjacent to the magnetic poles, on each side of the magnetic poles, to decrease the magnetic losses;
the kinetic plates comprise a shoulder surface, substantially parallel to the intermediate portion, located radially outwardly from the intermediate portion, and protruding from the center and intermediate portions in the direction of the magnetic plates, said shoulder surfaces bearing on the magnetic plates when the flywheel is assembled;
the shaft comprises:
a first and second ends,
a first bearing adjacent to the first end,
a shoulder, adjacent to said first bearing, having a diameter greater than the diameter of the bore of the kinetic plates,
a center portion, with a substantially constant section, receiving the kinetic plates and the magnetic plates,
a thread to receive a lock washer and a nut, said nut being secured by said lock washer,
a second bearing adjacent to the second end.

The above and other objects and advantages of the invention will become apparent from the detailed description of two embodiments of the invention, considered in conjunction with the accompanying drawings.

### BRIEF DESCRIPTION OF THE DRAWINGS

FIG. 1 is a diagram showing an autonomous power generating system in which the energy storage device according to the invention may be used;

FIG. 2 is a side sectional view of the flywheel according to a first embodiment of the invention;

FIG. 3 is a face sectional view of the flywheel of FIG. 2, the section being taken along the line III-III of FIG. 2;

FIG. 4 is a perspective exploded view of the flywheel of the preceding figures;

FIG. 5 is a sectional view of an energy storage device according to the invention, including the flywheel of FIGS. 2-4;

FIG. 6 is an enlarged view of part of FIG. 5; and

FIG. 7 is a perspective exploded view of the flywheel of a second embodiment of the invention.

### MORE DETAILED DESCRIPTION

In the various figures, the same references designate elements which are identical or similar.

FIG. 1 is a diagram showing an example of an autonomous power generating system in which the energy storage device according to the invention is used. Such a system comprises a heat engine 80 (Eng.) providing mechanical energy, an energy storage device 8 (Stor.), and a transmission arrangement 82 (Trans.) interposed between the heat engine 80 and the energy storage device 8. The transmission arrangement 82 may comprise a clutch and a variable speed gear device.

The energy storage device 8 is adapted to store kinetic energy and to supply electrical energy to a user circuit 86 (Use) from the kinetic energy.

A system controller 84 (Contr.) controls the heat engine 80, the transmission arrangement 82 and the energy storage device 8. This controller is able to:
control the delivery of electrical energy to the user circuit 86,
monitor the amount of energy stored in the energy storage device 8
control the operation of the heat engine 80 and the transmission arrangement 82 to supply or refill the energy storage device 8 when needed.

During some time periods, the heat engine is operating and providing mechanical energy to the energy storage device 8 through the transmission arrangement 82.

During other time periods, the heat engine is stopped, the transmission arrangement is unclutched and the energy storage device 8 alone supplies electrical energy to the user circuit 86 from the stored kinetic energy.

### First Embodiment

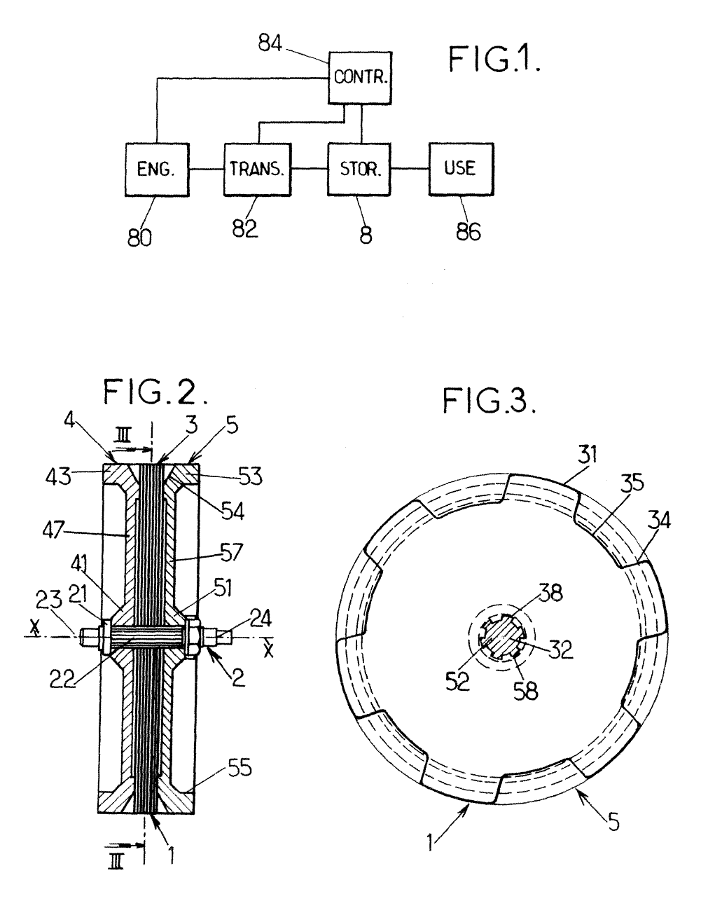

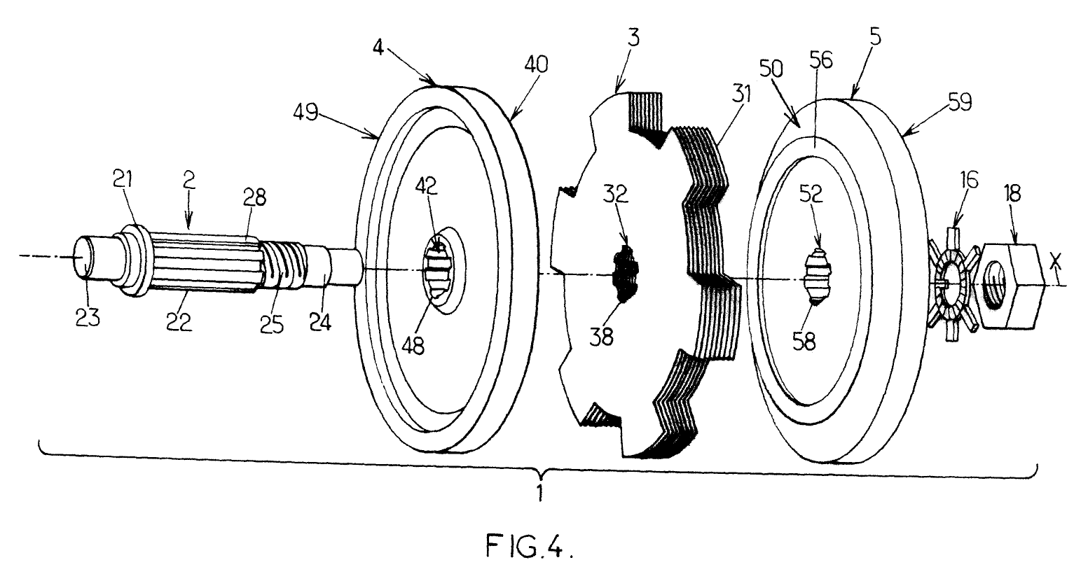

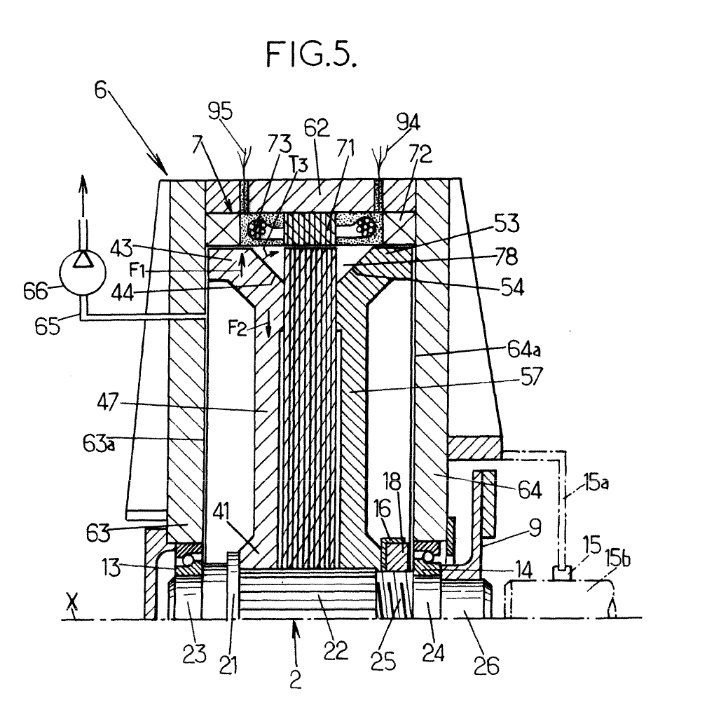

The energy storage device 8 comprises a flywheel 1 which is depicted on FIGS. 2, 3 and 4. This flywheel 1 rotates around an axis of rotation X, and comprises:
a shaft 2
a first kinetic plate 4
a plurality of magnetic plates 3
a second kinetic plate 5

The Shaft

The shaft 2 extends between a first and second ends and comprises:
a first bearing 23 adjacent to the first end, adapted to be received in the inner ring of a first roller bearing 13, said first roller bearing 13 being received in the centre of a first housing side plate 63,
a shoulder 21, adjacent to said first bearing 23, having a diameter greater than the diameter of the bore of the kinetic plates,
a center portion 22, with a substantially constant section, receiving the kinetic plates 4,5 and the magnetic plates 3,
a thread 25 to receive a lock washer 16 and a nut 18, said nut being rotationally secured by said lock washer,
a second bearing 24 adjacent to the second end, adapted to be received in the inner ring of a second roller bearing 14, said second roller bearing 14 being received in the center of a second housing side plate 64,
a third bearing 26 able to receive the clutch 9, which will be described later.

The center portion of the shaft is fitted with a plurality of splines 28 which cooperate with complementary grooves 38,48,58 located respectively in the center bores 32,42,52 of magnetic and kinetic plates 3,4,5. Said splines and grooves 38,48,58 allow the magnetic and kinetic plates 3,4,5 to slide from the second end to the center portion of the shaft along a direction parallel to the axis of rotation X, but render the magnetic and kinetic plates 3,4,5 rigid in rotation with said shaft 2 around the axis of rotation X.

The First Kinetic Plate

The first kinetic plate is extending perpendicularly to the axis X, between a back face 40 adjacent to the magnetic plates and a front face 49, parallel and opposite to said back face, and comprises:
a center portion 41 having a bore 42 with grooves being complementary with the splines of the shaft 2, said center portion 41 adapted to be mounted on the shaft 2,
a peripheral rim 43,
an intermediate portion 47 located radially between the central portion and the peripheral rim 43.

The peripheral rim 43 is thicker in a direction parallel to the rotation axis than said intermediate portion 47.

The first kinetic plate comprises on its back face 40 a shoulder surface 46, substantially parallel and protruding from the intermediate portion, and located radially outwardly from the intermediate portion.

The Magnetic Plates

A plurality of magnetic plates are disposed between first and second kinetic plates 4,5. The magnetic plates are substantially flat and parallel to each other, extending perpendicularly to the axis X. They comprise a plurality of axially protruding poles 31, and further comprise a plurality of recesses 35 extended between said poles 31, said poles and recesses being separated by radial surfaces 34.

The magnetic plates are made of a ferromagnetic permeable material, which enhances the magnetic performances of the energy storage device. They are coated with a thin insulating layer. As the plurality of magnetic plates are electrically insulated from each other, the losses due to Foucault currents are very low.

The Second Kinetic Plate

The second kinetic plate is similar to the first kinetic plate, symmetrically disposed with respect to a plane perpendicular to the axis X, comprising a center portion 51 having a bore 52, a peripheral rim 53, and an intermediate portion 57 located radially between the central portion and the peripheral rim 53. The second kinetic plate is extending perpendicular to the axis X, between a back face 50 adjacent to the magnetic plates and a front face 59.

The kinetic and magnetic plates have substantially the same diameter.

Assembly

The magnetic plates 3 and kinetic plates 4,5 are assembled on the shaft 2 between the shoulder 21 and the thread 25 in the order described here below.

Firstly, the first kinetic plate 4 is slided on the shaft from its second end in direction of its first end, until it reaches the shoulder 21. As the diameter of said shoulder is greater than the center bore 42, the first kinetic plate 4 is stopped and bears against the shoulder 21.

Secondly, the plurality of the magnetic plates 3 is slided on the shaft from its second end in direction of its first end until they reach the first kinetic plate 4. The first plate of the magnetic plates is bearing on the back face 40 of the first kinetic plate 4, in particular on the shoulder surface 46.

Thirdly the second kinetic plate 5 is slided on the shaft 2 from its second end in direction of its first end, until it reaches the magnetic plate 3. There the shoulder surface 56 of said second kinetic plate back face 50 is bearing against the magnetic plates 3.

Finally, a lock washer 16 and a nut 18 are introduced to lock the flywheel assembly. The lock washer 16 has foldable locking ears and cooperates with the nut 18 as known in the art, thus not described in details, to prevent any loosening of the assembly in service.

Housing

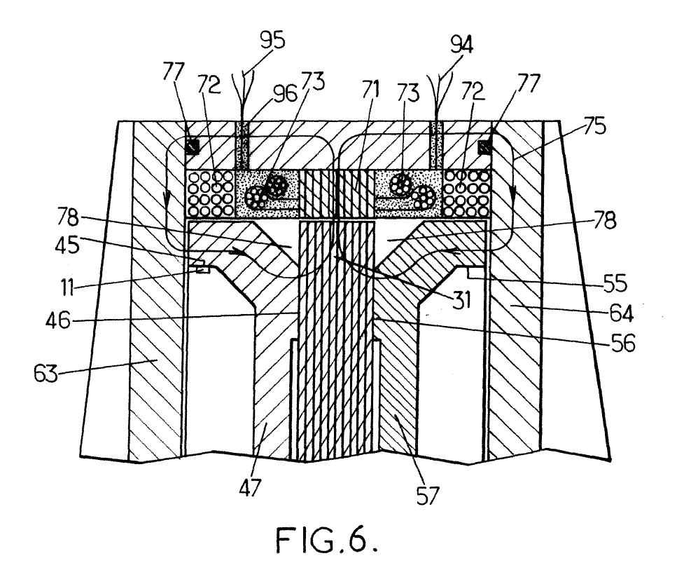

Referring now to FIGS. 5 and 6, the flywheel 1 is enclosed in a housing 6 comprising a first side plate 63, a second side plate 64 and a peripheral ring 62. The first side plate 63 comprises in its center a bearing to receive the first roller bearing 13. The second side plate 64 comprises in its center a bearing to receive the second roller bearing 14.

The stator arrangement 7 is adjacent to the peripheral ring 62, and is located radially inwardly from the peripheral ring 62. The stator arrangement faces the peripheral rims (43,53) of first and second kinetic plates and the peripheral area of the magnetic plates including the magnetic poles 31.

The stator arrangement comprises:
at least an excitation coil 72, extending perpendicularly to the axis X, and centered on the axis X,
a plurality of induction coils 73, extending substantially parallel to the peripheral ring 62 of the housing and facing the magnetic poles 31 of the flywheel 1,
at least a magnetic core 71 disposed in the middle section of the induction coil 73,
electrical wires 94,95 to deliver the output current to user circuit 86 (see FIG. 1).

The magnetic circuit is formed by the set of following elements:
magnetic poles 31,
magnetic core 71,
rims of first and second kinetic plates 4,5,
housing peripheral ring 62, and side plates 63,64.

The excitation magnetic field is created by the excitation coil 72 and the field lines follow a path 75 depicted in FIG. 6.

To improve magnetic circuit efficiency and decrease magnetic losses, bevels 44,54 are arranged at the radial end of kinetic plates back face 40,50. These bevels form on both side around the magnetic poles a peripheral empty wedge 78 between the bevels 44,54 and the magnetic poles 31. Hence all the field lines going through the stator magnetic core 71 are also going through a magnetic pole 31.

Kinetic Aspects

A target of the energy storage device according to the invention is to store a high amount of kinetic energy in a minimal volume, while minimizing the friction and magnetic losses. The kinetic energy is proportional to the flywheel moment of inertia and to the square of the rotation speed, so a high rotation speed should be reached. However, high rotation speed entails high centrifugal stresses undergone by the flywheel materials, and any deformation beyond elastic limit or any breakage due to fatigue must be avoided.

Hence the flywheel according to the invention comprises on one hand
the magnetic plates which are made of an iron alloy with good ferromagnetic permeability, said magnetic plates having a limited moment of inertia, and on the other hand,
the kinetic plates, with a high moment of inertia, and which are made preferably of a spheroidal graphite cast iron, resistant to stress and fatigue produced in the material by mechanical solicitations.

Preferably, the moment of inertia of the kinetic plates is fifty percent greater than the moment of inertia of the magnetic plates, and more preferably, the moment of inertia of the kinetic plates is ninety percent greater than the moment of inertia of the magnetic plates.

The spheroidal graphite cast iron of the kinetic plates is of particular interest because it contains a very high amount of small graphite spheres, having the ability to stop the progression of cracks that are prone to progression under alternate stresses known as fatigue phenomenon. Preferably, the spheroidal graphite cast iron chosen for the kinetic plates has a ferrite structure, and more preferably, it is chosen among cast iron references like EN-GJS-350 or EN-GJS-400.

Moreover, as it is known in the art, a bore drilling or hole locally increases the mechanical stress at the border of such a bore or drill. As a consequence, in order to avoid stress peaks on drilled areas, no hole is present in the kinetic and magnetic plates except the bore on the rotation axis. So it is possible to use the material at its maximal resistance capability, always staying below the elastic limit with a significant safety margin. The kinetic and magnetic plates are assembled tightly together without any hole except the bore on the rotation axis.

The flywheel assembly rotates at high speed so it must be well balanced to preclude the formation of vibrations due to unbalance. After parts manufacturing and assembly, the flywheel unbalance is measured. From this, a compensating balance mass 11 is defined and installed in the inner rim 45,55 of one or both of the kinetic plates. This inner rim extends radially inwardly, so the centrifugal force tends to urge the balance mass 11 against said inner rim. Anyway, for standstill and lower speeds, this balance mass is bonded with glue, again without any hole or drilled bore.

To decrease losses due to aerodynamic forces, the energy storage device according to the invention may comprise an airtight enclosure and a vacuum pump 66 linked to the airtight enclosure by a pipe 65. The airtight enclosure comprises seals 77 which are disposed between the housing peripheral ring 62, and the side plates 63,64. The airtight enclosure also comprises an auxiliary housing 15a and a gasket 15 bearing on the shaft 15b, to close the enclosure on the side of the transmission arrangement 82.

A side effect of having a low pressure in the airtight enclosure is a lack of convection exchanges. Besides, some losses due to Foucault current, although small, need to be evacuated from the flywheel to the housing. Thermal conduction is only possible through the balls of the ball bearings 13,14. As explained above, thermal convection is very limited due to low air pressure. According to the invention, the front face 49,59 of each kinetic plate is coated with paint, and the inner face 63a,64a of each housing side plate 63,64 is also coated with paint: as a result thermal radiated transmission is much better than thermal radiated transmission that would take place with uncoated machined material. The paint may be chosen so that it exhibits a relatively high coefficient of absorption for infrared light, in order to favour radiated heat transfer.

The stator coils 72,73 are connected to the system controller 84, via a plurality of wires 94,95. These wires 94,95 cross the housing peripheral ring 62 in pass-through apertures filled with a sealing gelly or resin material 96 known in the art, which perform airtightness by preventing gas or air transfer from outside into the airtight housing.

Besides the energy storage device comprises an interface with the transmission arrangement 82 (see FIG. 1) through a clutch disk 9 which is mounted on a bearing 26 on the shaft 2, adjacent to its second end (the rest of the clutch and the transmission arrangement is not shown).

The flywheel 1 according to the invention provides an additional advantage regarding dynamic stresses. In the kinetic plates, the inertia force generates a force F1 (see FIG. 5) directed radially outwardly, with an action point located in the rim area 43,53. An opposite reaction force F2 takes place and acts against inertia force. The reaction force has an application point located inside the kinetic plate intermediate portion 47,57. The vector sum of these forces F1,F2 is null, but the resulting moment T3 is not null and tends to twist the rim 43,53 in the direction of the magnetic plates. This produces a technical effect of reinforcing the sandwiching stress of the magnetic plates 3 in between the kinetic plates 4,5.

### Second Embodiment

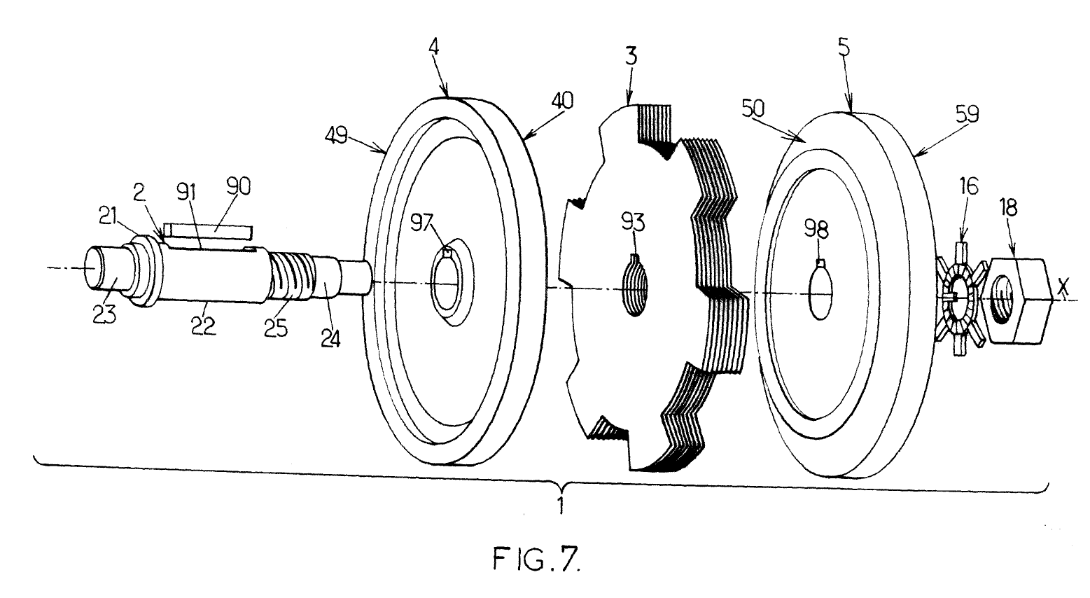

FIG. 7 shows a second embodiment of the energy storage device according to the invention. In this second embodiment of the invention, the energy storage device system is identical or similar to the one described in the first embodiment, thus it will not be described again. The housing 6 and the stator arrangement are also identical or similar to the ones described in the first embodiment, thus they will not be described again.

Only the flywheel assembly differs by the mechanical fitting on the shaft 2. The shaft comprises at least a longitudinal groove 91 extending along the rotation axis X and able to receive without clearance a locking pin 90. This locking pin 90 extends along the rotation axis X, has a smaller length than the shaft groove length, and has preferably a rectangular cross section partly received in the groove 91. When installed in the groove 91, the locking pin protrudes from the shaft periphery. The first kinetic plate 4 has a corresponding groove 94; the magnetic plates have each a corresponding groove 93 and finally the second kinetic plate 5 has a corresponding groove 95. The kinetic and magnetic plates are installed on the shaft 2 by a sliding movement from the second end of the shaft: when installed, the locking pin 90 is received in the plate grooves 93,97,98. The rest of the design of magnetic plates 3 is identical or similar to the design described in the first embodiment; besides the rest of the design of kinetic plates 4,5 is identical or similar to the design described in the first embodiment; thus the kinetic and magnetic plates are not described further in details.

1. An energy storage device comprising:
a flywheel rotatably mounted around a rotation axis,
said flywheel comprising a shaft and a plurality of magnetic poles,
a stator arrangement, facing the magnetic poles of said flywheel, comprising a plurality of induction coils cooperating with said magnetic poles,
a housing enclosing the flywheel and the stator arrangement,
characterized wherein the flywheel comprises:
a plurality of adjacent magnetic plates, mounted on said shaft, comprising radial protrusions forming the magnetic poles, and extending in parallel radial plates,
a first and second kinetic plates, sandwiching the magnetic plates, parallel to said magnetic plates,
wherein the magnetic plates and kinetic plates are rotationally rigid with said shaft, and extend radially relative to the shaft.

2. The energy storage device according to claim 1, wherein the magnetic plates have an external diameter and the kinetic plates have an external diameter which is greater than seventy percent of the external diameter of the magnetic plates.

3. The energy storage device according to claim 1, wherein the first and second kinetic plates have together a first moment of inertia and the magnetic plates have together a second moment of inertia, and the first moment of inertia is greater than the second moment of inertia.

4. The energy storage device according to claim 1, wherein the shaft comprises at least a spline, each of the magnetic plates and the kinetic plates having at least a complementary groove receiving said spline, so that the magnetic plates and kinetic plates are rotationally rigid with said shaft.

5. The energy storage device according to claim 1, comprising a locking pin, wherein the shaft comprises a groove and wherein each of the magnetic plates and the kinetic plates have a corresponding groove, so that the locking pin is lodged in said grooves, to render the magnetic plates and kinetic plates rotationally rigid with said shaft.

6. The energy storage device according to claim 1, wherein the kinetic plates are made of spheroidal graphite cast iron.

7. The energy storage device according to claim 6, wherein the spheroidal graphite cast iron has a ferrite structure.

8. The energy storage device according to claim 1, wherein the kinetic plates comprise a central portion, a peripheral rim and an intermediate portion which is located radially between the central portion and the peripheral rim, said peripheral rim being thicker in a direction parallel to the rotation axis than said intermediate portion, and said peripheral rim protruding axially in a direction opposite to the magnetic plates.

9. The energy storage device according to claim 1, wherein the kinetic plates are monoblock and axisymmetric.

10. The energy storage device according to claim 1, further comprising a balance mass bonded on an inner rim belonging to at least one of the kinetic plates, said inner rim being oriented radially inwardly.

11. The energy storage device according to claim 1, wherein the housing is an airtight housing, and the energy storage device further includes a vacuum pump for creating a vacuum inside said housing.

12. The energy storage device according to claim 1, wherein the kinetic plates are at least partially coated with paint and wherein the inner sides of the housing facing the kinetic plates are coated with paint, said paint being adapted to favour radiated heat transfer.

13. The energy storage device according to claim 1, wherein the stator arrangement comprises at least an excitation coil, and at least an inducted coil, forming a magnetic circuit with the magnetic poles and the housing.

14. The energy storage device according to claim 1, wherein the kinetic plates comprise a bevel at the peripheric area facing the magnetic plates, said bevel forming with the magnetic plates an empty wedge adjacent to the magnetic poles, on each side of the magnetic poles, to decrease the magnetic losses.

15. The energy storage device according to claim 1, wherein the kinetic plates comprise a central portion, a peripheral rim and an intermediate portion which is located radially between the central portion and the peripheral rim, and wherein said kinetic plates comprise a shoulder surface, substantially parallel to the intermediate portion, located radially outwardly from the intermediate portion, and protruding from the center and intermediate portions in the direction of the magnetic plates, said shoulder surfaces bearing on the magnetic plates when the flywheel is assembled.

16. The energy storage device according to claim 1, wherein the shaft comprises:
a first and second ends
a first bearing adjacent to the first end,
a shoulder, adjacent to said first bearing, having a diameter greater than the diameter of the bore of the kinetic plates,
a center portion, with a substantially constant section, receiving the kinetic plates and the magnetic plates,
a thread to receive a lock washer and a nut, said nut being secured by said lock washer,
a second bearing adjacent to the second end.
